(19) United States
(12) Patent Application Publication
(10) Pub. No.: US 2008/0025520 A1
(43) Pub. Date: Jan. 31, 2008

(54) Volume controlling technique

(76) Inventors: Mitsuteru Sakai, Ukyo-Ku (JP); Yosuke Sato, Ukyo-Ku (JP)

Correspondence Address: CANTOR COLBURN, LLP, 55 GRIFFIN ROAD SOUTH, BLOOMFIELD, CT, 06002, US

(21) Appl. No.: 11/881,451

(22) Filed: Jul. 27, 2007

(30) Foreign Application Priority Data
Jul. 27, 2006 (JP) 2006-205240

(51) Int. Cl. H04S 3/00

(52) U.S. Cl. 381/28

(57) ABSTRACT

A gain switching unit receives each of plural gain control data at a different timing, and repeats that process until a switching instruction data is received. Upon receipt of the switching instruction data, the gain switching unit, based on the plural gain control data received so far, switches at an equal timing the respective gain of the variable gain amplifier of each channel that the plural gain control data intend respectively as an object of volume switching.

### BACKGROUND OF THE INVENTION

1. Field of the Invention

The present invention relates to a technique of amplifying sound signals of plural channels.

2. Description of the Related Art

In order to realize acoustic effects being three-dimensional and giving a sense of presence, sound signals are coming to be provided in multiple channels, and the number of speakers that are used is outstandingly increasing. For example, in recent years, the 5.1 channel which is prevalent in acoustic systems in the field of cinemas is coming to be applied to DVD-videos, digital broadcasts, car audio system, and the like. The 5.1 channel basically has 6 channels including front left, front right, rear left, rear right, center, and subwoofer. In the field of car audio system, it is sometime carried out that the persons in the rear seats listen to sounds from a DVD player while the persons in the front seats listen to the sounds of a car navigation system. In accordance with such a stream also, the increase in the number of speakers is advancing.

As a technique related to amplification of sound signals, one intended to reduce the noise at the time of volume switching is proposed (see a patent document 1 below). The patent document 1 discloses a technique of reducing the shock sound at the time of volume switching by smoothly changing an output for volume control.

### [Patent Document 1] Japanese Patent Application Laid-Open (JP-A) No. 2002-26670

### [Patent Document 2] Japanese Patent Application Laid-Open (JP-A) No. 2005-286532

In considering switching the volume in an acoustic system intended for sound signals of plural channels, the present inventors and others recognized problems as follows.

For example, when volume data for each channel is transmitted from a microcomputer in accordance with a volume switching instruction from a user, the volume data of each channel is received by the volume control side with a time lag because of the restrictions on the bus that connects the microcomputer to the volume control side. This leads to generation of a time lag also in switching the volume for each channel, whereby the user will feel a sense of inconsistency. This will be more considerable according as the number of the channels increases.

As a countermeasure against this, one can consider, for example, enlarging the bus width of the bus that connects the microcomputer to the volume control side, or using a bus having a larger transfer speed even with the same bus width. However, enlarging the bus width leads to increase in the number of pins, whereas increasing the transfer speed leads to increase in the electric power consumption. Also, these countermeasures may have a fear of inhibiting the use of a standard bus. Therefore, under current circumstances, one cannot but say that it is unrealistic to eliminate the time lag in receiving the volume data.

Also, in the case of using the technique of countermeasures against the switching noise such as disclosed in the patent document 1, if the construction for moderating the change in the output for volume control is used in common for plural channels due to the restrictions on the circuit scale, it so happens that, while an output for volume control is moderately being changed for one channel, the volume of other channels cannot be changed. As a result of this, the sense of inconsistency that the user feels due to the time lag will be more serious. For example, in a system of the 5.1 channel, when the volume is switched in the order from the center to the front right, then to the rear right, then to the rear left, and then to the front left, the user will feel that the sound is rotating.

### SUMMARY OF THE INVENTION

The present invention has been made by recognizing such a circumstance, and a general purpose thereof is to equalize the volume switching timing of each channel at the time of volume switching of the sound signals of plural channels.

One embodiment of the present invention is a sound signal amplifying circuit. This circuit includes plural variable gain amplifiers that amplify sound signals of plural channels, channel by channel, and a gain switching unit that switches the gain of the plural variable gain amplifiers based on the plural gain control data that individually designate the volume of each channel. The gain switching unit receives each of the plural gain control data at a different timing and, upon receipt of a switching instruction data that instructs switching of the gain, the gain switching unit, based on the plural gain control data received so far, switches at an equal timing the gain of the variable gain amplifier of each channel that the plural gain control data intend respectively as an object of volume switching.

According to this embodiment, the gain of the variable gain amplifier of each channel is switched upon receipt of the switching instruction data, so that the switching timing of the volume of each channel can be equalized.

Another embodiment of the present invention also is a sound signal amplifying circuit. This circuit includes plural variable gain amplifiers that amplify sound signals of plural channels, channel by channel, and a gain switching unit that switches the gain of the plural variable gain amplifiers based on the plural gain control data that individually designate the volume of each channel. The gain switching unit receives each of the plural gain control data at a different timing and, after waiting for completion of the receipt of the gain control data of the channels for which the volume is to be switched, the gain switching unit, based on the received plural gain control data, switches at an equal timing the gain of the variable gain amplifier of each channel.

According to this embodiment, since the gain of the variable gain amplifier of each channel is switched after waiting for completion of the receipt of the gain control data of the channels for which the volume is to be switched, the switching timing of the volume of each channel can be equalized.

Still another embodiment of the present invention is an audio apparatus. This apparatus includes a sound signal amplifying circuit described above, a microprocessor that transmits each of the plural gain control data to the sound signal amplifying circuit in accordance with an instruction from a user, and a bus that connects this microprocessor to the sound signal amplifying circuit.

According to this embodiment, the value of the audio apparatus can be raised because a natural volume-switching operation giving little sense of inconsistency can be realized in accordance with the user instruction.

Still another embodiment of the present invention is a volume-switching method that switches the volume of the sound signals of plural channels. This method includes a step in which a microprocessor generates, based on a volume switching instruction from a user, plural gain control data that individually designate the volume of each channel serving as an object of volume switching; a step in which the microprocessor transmits each of the plural gain control data to a sound signal amplifying circuit at a different timing; a step in which the sound signal amplifying circuit receives each of the plural gain control data at a different timing; a step in which the microprocessor transmits, after transmitting each of the plural gain control data, a switching instruction data that instructs switching of the gain to the sound signal amplifying circuit; and a step in which, upon receipt of the switching instruction data, the sound signal amplifying circuit, based on the received plural gain control data, switches at an equal timing the gain of the variable gain amplifier of each channel that the plural gain control data intend respectively as an object of volume switching.

Still another embodiment of the present invention also is a volume-switching method that switches the volume of the sound signals of plural channels. This method includes a step in which a microprocessor generates, based on a volume switching instruction from a user, plural gain control data that individually designate the volume of each channel serving as an object of volume switching; a step in which the microprocessor transmits each of the plural gain control data to a sound signal amplifying circuit at a different timing; a step in which the sound signal amplifying circuit receives each of the plural gain control data at a different timing; a step in which the sound signal amplifying circuit waits for completion of the receipt of the plural gain control data; and a step in which the sound signal amplifying circuit, based on the received plural gain control data, switches at an equal timing the gain of the variable gain amplifier of each channel.

It is to be noted that any arbitrary combination or rearrangement of the above-described structural components and so forth is effective as and encompassed by the present embodiments. Moreover, this summary of the invention does not necessarily describe all necessary features so that the invention may be also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a view conceptually showing a construction of an audio system according to an embodiment.

FIG. 2 is a view showing a format of the bus of FIG. 1 and showing the gain control data that are transmitted from a microprocessor to a sound signal amplifying circuit.

FIG. 3 is a view showing a case in which plural gain control data of FIG. 2 are arranged.

FIG. 4 is a circuit diagram showing a construction of the sound signal amplifying circuit of FIG. 1.

FIG. 5 is a flowchart showing a gain switching operation in the audio apparatus of FIG. 1.

FIG. 6 is a flowchart showing another gain switching operation in the audio apparatus of FIG. 1.

FIG. 7 is a view showing a volume switching waveform in the Comparative Example.

FIG. 8 is a view showing a volume switching waveform in the present embodiment.

### DETAILED DESCRIPTION OF THE INVENTION

The invention will now be described based on preferred embodiments which do not intend to limit the scope of the present invention but exemplify the invention. All of the features and the combinations thereof described in the embodiments are not necessarily essential to the invention.

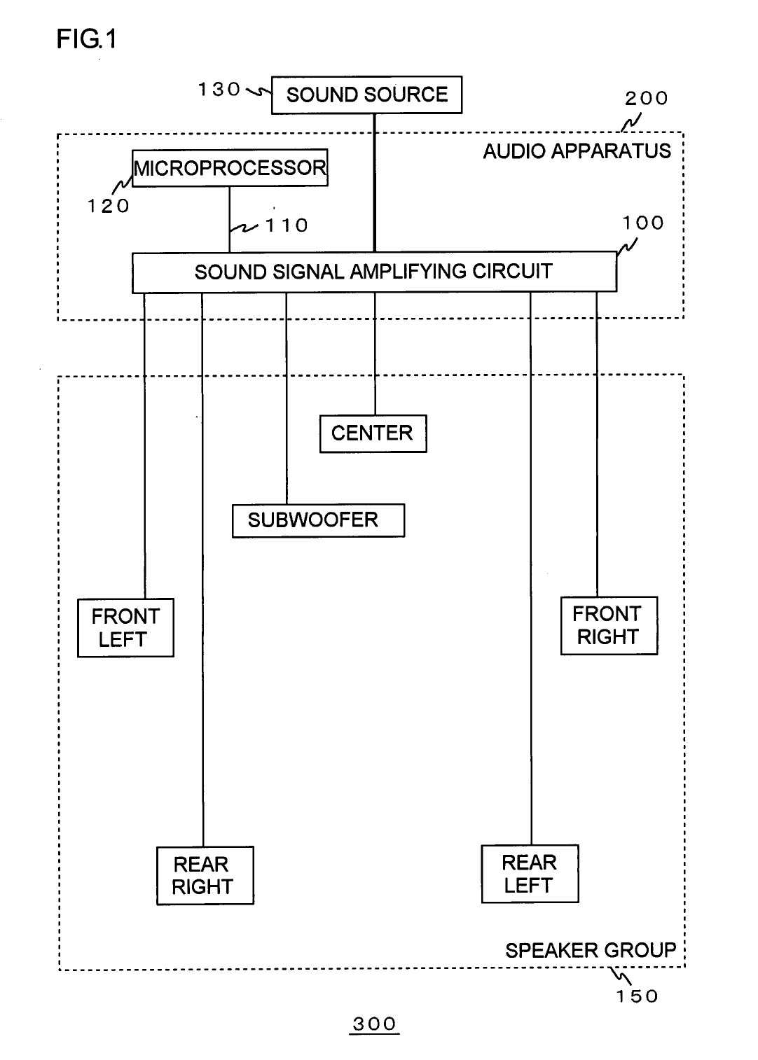

FIG. 1 conceptually shows a construction of an audio system 300 according to an embodiment. The audio system 300 can be applied, for example, to various acoustic systems such as a home theater or a car audio system. Here, the specific usage thereof will not be particularly limited, and the audio system 300 will be described as a system of 5.1 channel for exemplification.

The audio system 300 includes a sound source 130, an audio apparatus 200, and a speaker group 150.

The audio apparatus 200 includes a sound signal amplifying circuit 100 and a microprocessor 120. The audio apparatus 200 is, for example, a deck of a home theater or a car audio system.

The sound signal amplifying circuit 100 and the microprocessor 120 are connected via a bus 110. The bus 110 may be, for example, a serial bus such as an I2C (Inter-IC Control) bus.

The sound source 130 inputs sound signals corresponding to the 5.1 channel into the sound signal amplifying circuit 100. Here, though the sound signals are provided in multiple channels, the path that connects the sound source 130 to the sound signal amplifying circuit 100 is denoted by one thick solid line in FIG. 1.

The sound signal amplifying circuit 100 amplifies the input sound signals channel by channel, and outputs them respectively to corresponding speakers.

The speaker group 150 is made of six speakers corresponding to the respective channels of front left, front right, rear left, rear right, center, and subwoofer. Each speaker receives the amplified output of the sound signal from the sound signal amplifying circuit 100, and converts it into sound for output.

Based on an instruction from a user, the microprocessor 120 transmits plural gain control data that respectively individually designate the volume of the channels, to the sound signal amplifying circuit 100 via the bus 110. Based on the gain control data, the gain of the sound signal amplifying circuit 100 is determined.

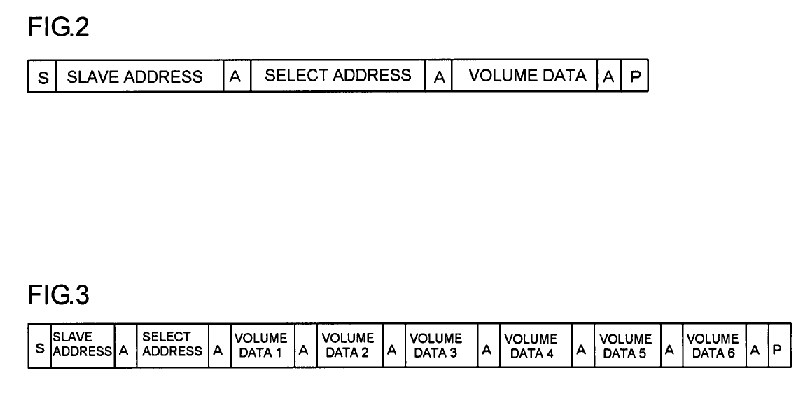

FIG. 2 shows a format of the bus 110 of FIG. 1, and also shows the gain control data that are transmitted from the microprocessor 120 to the sound signal amplifying circuit 100. Here, description will be given by taking a format of the I2C bus as an example.

The gain control data includes a slave address, a select address, and a volume data. These are each a data of 8 bits, and the microprocessor 120 generates each 8 bits based on an instruction from a user. At the beginning part of the format, 1 bit (S: Start condition) for showing the head part is inserted. After the slave address, the select address, and the volume data, 1 bit (A: Acknowledge bit) is respectively present for showing that each 8 bits have been received. At the last part of the format, 1 bit (P: Stop condition) is inserted for showing the end.

The slave address specifies a device serving as an object of operation. When an instruction for volume adjustment is given, the data specifying the sound signal amplifying circuit 100 enters here.

When an instruction for volume adjustment is given, the select address designates the channel serving as an object of volume adjustment.

The volume data designates the volume of the designated channel. This is equivalent to designating the gain of the variable gain amplifier of that channel.

Here, though description has been given by assuming that the format including all of the slave address, the select address, and the volume data constitutes one gain control data, the select address and the volume data can be regarded as one gain control data without including the slave address. Alternatively, the volume data can be regarded as one gain control data without including the slave address and the select address. In short, the gain control data can be understood to be the data such that, when received, the channel serving as an object of gain adjustment and the targeted volume in that channel can be grasped. Nevertheless, the phrase “the gain can be grasped” is not limited to the case in which the gain can be grasped by receiving the single body of the gain control data but is used to include a case in which the gain can be grasped by mutual relationship with the data that are present before and after that.

FIG. 3 shows a case in which plural gain control data of FIG. 2 are arranged. The slave address and the select address may be transmitted each time in order to designate the volume for each channel. However, in the format of FIG. 3, the slave address and the select address are transmitted only once in order to enhance the transfer efficiency. For example, the volume data 1 may be set as a data of the channel designated by the select address; the volume data 2 may be set as a data of the channel designated by the select address +1; and similarly the volume data 3 to 6 may be set as data of the channels designated by the select address +2 to +5. By such a setting, the volume data 1 to 6 can be transmitted, for example, as a sequential gain control data series for the center, for the front right, for the rear right, for the rear left, for the front left, and for the subwoofer even in the case in which the slave address and the select address are transmitted only once.

In FIG. 3, the select address and the volume data 1 as well as each of the volume data 2 to 6 can be regarded as the gain control data. It will be understood from FIG. 3 that each of the plural gain control data is received at a different timing. In other words, the sound signal amplifying circuit 100 sequentially receives the plural gain control data channel by channel.

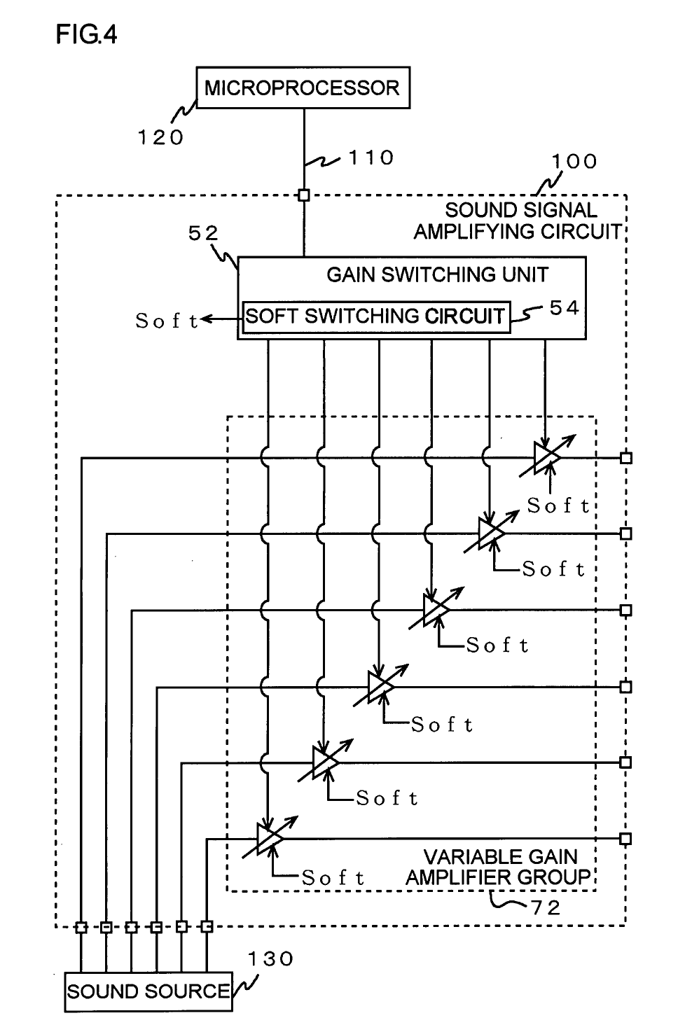

FIG. 4 shows a construction of the sound signal amplifying circuit 100 of FIG. 1. In FIG. 4, constituent elements that are identical with or similar to those shown in FIG. 1 will be denoted with the same reference numerals, and the description thereof will not be repeated. The sound signal amplifying circuit 100 is integrated on one semiconductor substrate. Here, the term “integration” includes a case in which all of the constituent elements of the circuit are formed on the semiconductor substrate and a case in which the principal constituent elements of the circuit are integrated, where a part of the resistors and the like may be disposed outside of the semiconductor substrate for adjustment of the circuit constants. Integration on one semiconductor substrate facilitates mounting on an electronic apparatus such as the audio apparatus 200.

The sound signal amplifying circuit 100 includes a variable gain amplifier group 72 and a gain switching unit 52. The gain switching unit 52 has a soft switching circuit 54. Here, illustration of a memory that buffers the data coming from the microprocessor 120 is not shown.

The variable gain amplifier group 72 is made of variable gain amplifiers each provided for the corresponding channel. The variable gain amplifier of each channel amplifies the sound signal that is input from the sound source 130, and outputs it to the speaker of the corresponding channel.

The gain switching unit 52 receives the plural gain control data that individually designate the volume of each channel from the microprocessor 120 via the bus 110, and switches the gain of the variable gain amplifier of each channel.

The soft switching circuit 54 is a circuit for smoothening the change in the volume at the time of volume switching of each channel. As a technique for smoothening the change in the volume, a known technique such as shown in the aforementioned patent documents 1 and 2 can be used, for example. The soft switching circuit 54 is used in common for volume switching of all the channels. Here, in FIG. 4, the signal that the soft switching circuit 54 outputs for smoothening the change of the gain is denoted as “Soft”.

Even if the gain switching unit 52 receives again control data, the gain switching unit 52 does not immediately switch the gain of the variable gain amplifier of the channel that the gain control data intends as an object of volume switching. Instead, the gain switching unit 52 switches the gain upon receipt of a later-mentioned switching instruction data, or, alternatively, the gain switching unit 52 switches the gain after waiting for completion of the receipt of the gain control data for each channel for which the volume is to be switched.

The switching instruction data may be, for example, a data that designates the address provided for instruction of switching to the select address of the format of FIG. 3 and includes a predetermined bit pattern in place of the volume data. In order to find the completion of receipt of the gain control data for each channel for which the volume is to be switched, the last one bit (P) of FIG. 3 may be used. Here, typically, the volume of all the channels is switched by one instruction, so that the completion of the receipt of the volume data 1 to 6 means that the receipt of the gain control data for each channel for which the volume is to be switched has been completed. Nevertheless, when there is no need to switch the volume for a part of the channels, the channels other than that part of the channels correspond to the channels for which the volume is to be switched. Such a circumstance may occur, for example, in the case in which sounds from different sound sources are supplied to front and rear seats in a car audio system.

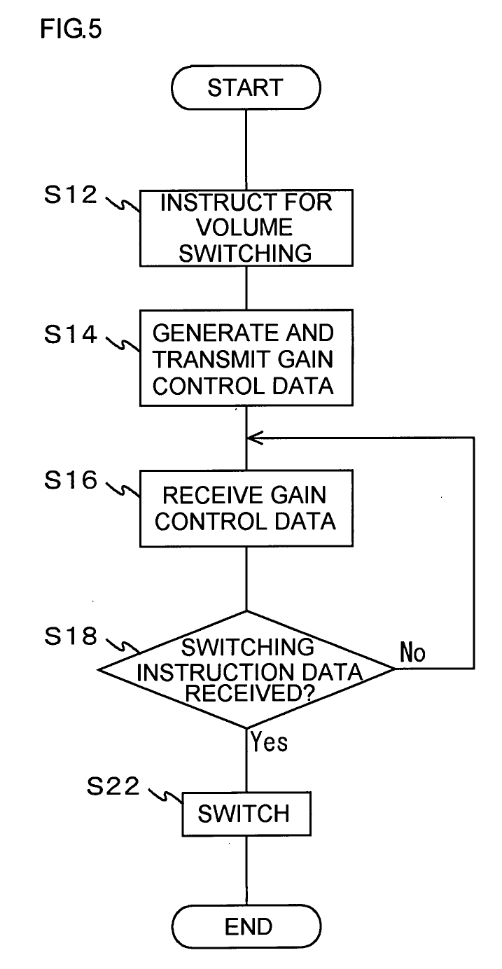

FIG. 5 is a flowchart showing a gain switching operation in the audio apparatus 200 of FIG. 1.

A user of the audio apparatus 200 gives an instruction for switching of the volume, for example, by button operation or the like (S12). Based on the instruction from the user, the microprocessor 120 generates plural gain control data that individually designate the volume of each channel, and transmits the data to the gain switching unit 52 of the sound signal amplifying circuit 100 (S14). The gain switching unit 52 receives each of the plural gain control data at a different timing (S16), and repeats that process until a switching instruction data is received (S18•No). Upon receipt of the switching instruction data (S18•Yes), the gain switching unit 52, based on the plural gain control data received so far, switches at an equal timing the respective gain of the variable gain amplifier of each channel that the plural gain control data intend respectively as an object of volume switching (S22).

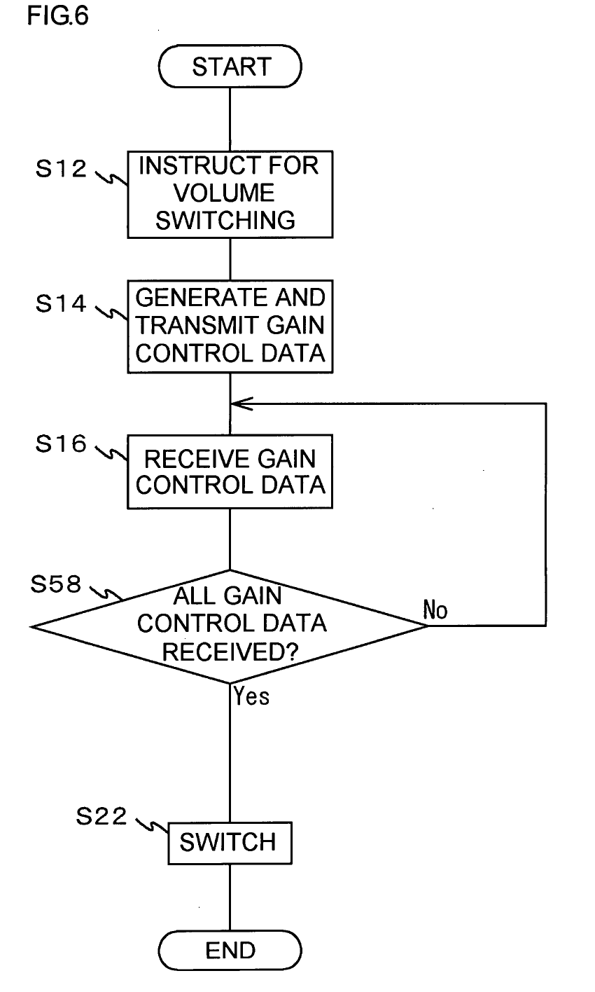

FIG. 6 is a flowchart showing another gain switching operation in the audio apparatus 200 of FIG. 1. In FIG. 6, steps that are identical with or similar to those shown in FIG. 5 will be denoted with the same reference numerals, and the description thereof will not be repeated.

In the operation shown in FIG. 5, the gain of the variable gain amplifiers is switched upon receipt of the switching instruction data. In the operation shown in FIG. 6, the receipt of the gain control data is repeated until the receipt of the gain control data is completed for each channel for which the volume is to be switched (S58•No) and, after waiting for the completion thereof (S58•Yes), the gain of the variable gain amplifiers is switched (S22). Here, the phrase “all the gain control data” in S58 means all of the gain control data of the channels for which the volume is to be switched. The channels for which the volume is to be switched may be in some cases all the channels, and depending on the circumstances described above, may be in other cases the channels excluding a part of the channels.

According to the present embodiment, the sound signal amplifying circuit 100 switches at an equal timing the gain of the variable gain amplifier of each channel, so that the timing of the volume switching of the sound that is output from the speaker of each channel can be equalized. This can reduce the sense of inconsistency that the user feels at the time of volume switching, thereby leading to an improvement in the value of the audio apparatus 200.

Also, in the present embodiment, in order to equalize the timing of volume switching, the volume is switched upon receipt of the switching instruction data or after waiting for completion of the receipt of the gain control data for each channel for which the volume is to be switched. For this reason, there is no need to add a particular alteration to the circuit construction of sound amplification in order to equalize the timing. Even if there is a need, it suffices to increase the memory capacity a little, so that the sound signal amplifying circuit 100 can be realized with a simple construction. Also, there is no need to increase the bus width of the bus that connects the microprocessor 120 to the sound signal amplifying circuit 100 or to increase the data transfer speed of the bus as compared with already existing ones, so as to equalize the timing. This enables use of a serial bus such as an I2C bus, so that the audio apparatus 200 makes use of such a bus. Therefore, one can say that the application range of the audio apparatus 200 is considerably wide.

Also, since the change in the gain of the variable gain amplifier at the time of volume switching is smoothened by the soft switching circuit 54, the shock sound at the time of switching is prevented. Also, since the soft switching circuit 54 is used in common for the variable gain amplifier of each channel, the increase in the circuit scale can be restrained. Here, when the soft switching circuit 54 is used in common, the sense of inconsistency at the time of volume switching will be more serious if the gain of the variable gain amplifier is switched each time the gain control data is received. In contrast, in the present embodiment, such a problem is suitably solved because the timing of gain switching of the variable gain amplifier is equalized in the manner described above.

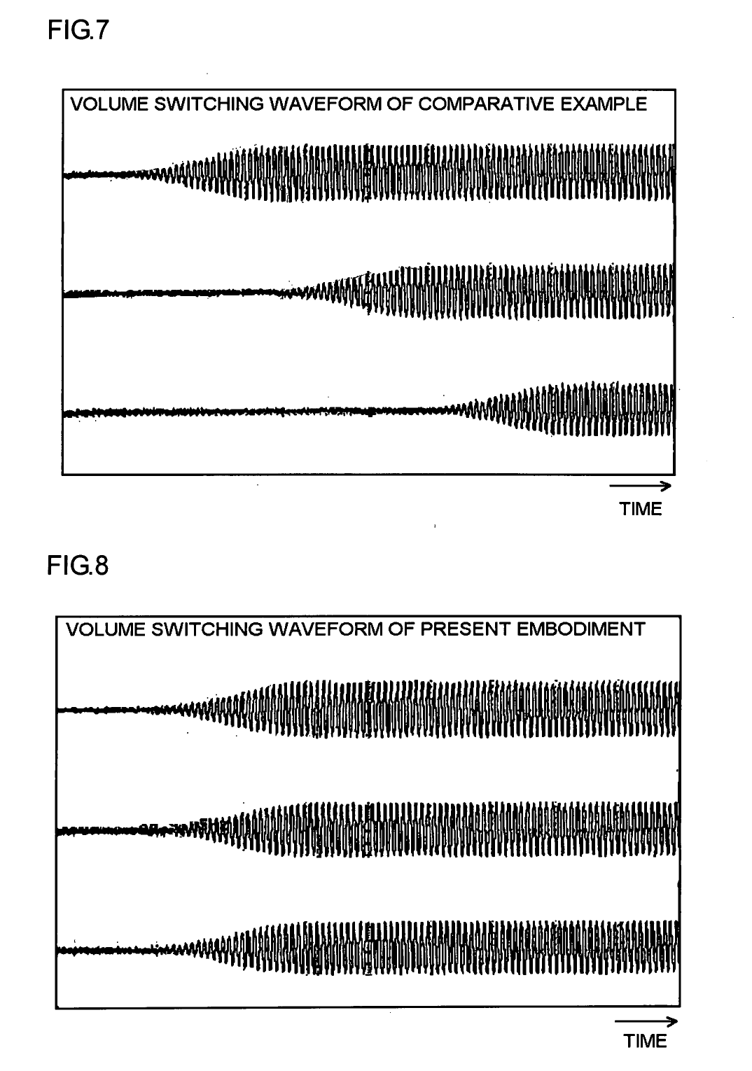

In order to understand the effects of the present embodiment clearly, the volume switching waveforms of FIGS. 7 and 8 will be compared. FIG. 7 shows a volume switching waveform in the Comparative Example. FIG. 8 shows a volume switching waveform in the present embodiment.

The Comparative Example is an example such that, in the construction in which the soft switching circuit 54 is used in common, the gain of the variable gain amplifier is switched each time the gain control data is received. In the case of the Comparative Example, the soft switching circuit 54 is operated for the number of times equal to the number of the channels, so that, while the volume is being gradually changed for one channel, one must wait for switching of the volume for other channels. In other words, after waiting for the end of the gradual volume-switching for the first channel, the volume of the next channel is gradually switched, and moreover, during that period, the further next channel is still in a state of waiting for switching. Therefore, the waveform will be a switching waveform having a time lag for each channel as shown in FIG. 7, so that the user will feel a sense of inconsistency each time the volume is switched.

In contrast, in the present embodiment, the gain of the variable gain amplifier of each channel is switched at an equal timing in the manner described above, so that only one operation of the soft switching circuit 54 will be needed for one volume switching. As a result of this, a waveform of simultaneous switching is obtained which is different from that of the Comparative Example, as shown in FIG. 8. Therefore, the sense of inconsistency that the user feels at the time of volume switching is reduced, thereby realizing a natural volume switching.

The above-described embodiment is an exemplification, so that it will be understood by those skilled in the art that various modifications can be made on the combination of the constituent elements and treating processes thereof, and that those modified examples are also within the scope of the present invention. Hereafter, modified examples will be shown.

In the embodiment, the bus that connects the microprocessor 120 to the sound signal amplifying circuit 100 is assumed to be a serial bus; however, the present invention is not limited to this, so that a parallel bus may be used as well.

In the embodiment, the gain switching unit 52 switches the gain of the variable gain amplifier of each channel at an equal timing. A modified example is so constructed that, in addition to this, the gain switching unit 52 can also perform an operation of switching the gain of the variable gain amplifier each time the gain control data is received. Which operation is to be executed may be suitably determined in accordance with a setting in advance. This will give a degree of freedom in selection on the side of the user.

In the embodiment, the soft switching circuit 54 is used in common for all the channels; however, the present invention is not limited to this, so that the soft switching circuit 54 may not be used in common for a part of the channels. Also, if there is no need to smoothen the change in the gain of the variable gain amplifier for a part of the channels, there is no need to use the soft switching circuit 54 for the variable gain amplifiers of those channels. This increases the degree of freedom in circuit designing.

In the embodiment, the audio system 300 has been described as a system of the 5.1 channel; however the present invention is not limited to this, either. The number of channels for sound signals is arbitrary as long as the number is plural.

While the preferred embodiments of the present invention have been described using specific terms, such description is for illustrative purposes only, and it is to be understood that changes and variations may be made without departing from the spirit or scope of the appended claims.

What is claimed is:

1. A sound signal amplifying circuit comprising:
a plurality of variable gain amplifiers that amplify sound signals of plural channels, channel by channel; and
a gain switching unit that switches the gain of the plurality of variable gain amplifiers based on a plurality of gain control data that individually designate the volume of each channel,
wherein
the gain switching unit receives each of the plurality of gain control data at a different timing and, upon receipt of a switching instruction data that instructs switching of the gain, the gain switching unit, based on the gain control data received so far, switches at an equal timing the gain of the variable gain amplifier of each channel that the plural gain control data intend respectively as an object of volume switching.

2. The sound signal amplifying circuit according to claim 1, wherein
the gain switching unit receives each of the plurality of gain control data via a serial bus.

3. The sound signal amplifying circuit according to claim 1, wherein
the gain switching unit receives each of the plurality of gain control data via an I2C (Inter-IC Control) bus.

4. The sound signal amplifying circuit according to claim 1, wherein
the gain switching unit is constructed to be capable of executing also an operation of switching the gain of a variable gain amplifier each time a gain control data is received and, in accordance with a setting in advance, the gain switching unit switches the gain of the variable gain amplifier each time the gain control data is received, instead of switching at an equal timing the gain of the variable gain amplifier of each channel.

5. The sound signal amplifying circuit according to claim 1, wherein
the gain switching unit has a soft switching circuit that smoothens the change of volume at the time of volume switching of each channel, and this soft switching circuit is used in common for volume switching of at least two channels.

6. The sound signal amplifying circuit according to claim 1, being integrated on one semiconductor substrate.

7. An audio apparatus comprising:
a sound signal amplifying circuit according to claim 1;
a microprocessor that transmits each of the plurality of gain control data to the sound signal amplifying circuit in accordance with an instruction from a user; and
a bus that connects the microprocessor to the sound signal amplifying circuit.

8. A sound signal amplifying circuit comprising:
a plurality of variable gain amplifiers that amplify sound signals of a plurality of channels, channel by channel; and
a gain switching unit that switches the gain of the plurality of variable gain amplifiers based on the plurality of gain control data that individually designate the volume of each channel,
wherein
the gain switching unit receives each of the plurality of gain control data at a different timing and, after waiting for completion of the receipt of the gain control data of the channels for which the volume is to be switched, the gain switching unit, based on the received plurality of gain control data, switches at an equal timing the gain of the variable gain amplifier of each channel.

9. The sound signal amplifying circuit according to claim 8, wherein
the gain switching unit receives each of the plurality of gain control data via a serial bus.

10. The sound signal amplifying circuit according to claim 8, wherein
the gain switching unit receives each of the plurality of gain control data via an I2C (Inter-IC Control) bus.

11. The sound signal amplifying circuit according to claim 8, wherein
the gain switching unit is constructed to be capable of executing also an operation of switching the gain of a variable gain amplifier each time a gain control data is received and, in accordance with a setting in advance, the gain switching unit switches the gain of the variable gain amplifier each time the gain control data is received, instead of switching at an equal timing the gain of the variable gain amplifier of each channel.

12. The sound signal amplifying circuit according to claim 8, wherein
the gain switching unit has a soft switching circuit that smoothens the change of volume at the time of volume switching of each channel, and that this soft switching circuit is used in common for volume switching of at least two channels.

13. The sound signal amplifying circuit according to claim 8, being integrated on one semiconductor substrate.

14. An audio apparatus comprising:
a sound signal amplifying circuit according to claim 8;
a microprocessor that transmits each of the plurality of gain control data to the sound signal amplifying circuit in accordance with an instruction from a user; and
a bus that connects the microprocessor to the sound signal amplifying circuit.
